(19) United States
(12) Patent Application Publication
(10) Pub. No.: US 2009/0207167 A1
(43) Pub. Date: Aug. 20, 2009

(54) Method and System for Remote Three-Dimensional Stereo Image Display

(75) Inventor: Davide Pasetto, Dublin (IE)

Correspondence Address: MARK P. KAHLER, 8101 VAILVIEW COVE, AUSTIN, TX, 78750, US

(73) Assignee: International Business Machines Corporation, Armonk, NY (US)

(21) Appl. No.: 12/368,695

(22) Filed: Feb. 10, 2009

(30) Foreign Application Priority Data
Feb. 18, 2008 (EP) 08151558.7

(51) Int. Cl. G06T 15/00; G06K 9/36; H04N 13/00

(52) U.S. Cl. 345/419; 382/232; 345/545; 348/42; 348/E13.004

(57) ABSTRACT

An information handling system (IHS) for three-dimensional (3D) image processing may include a stereo image frame buffer that stores two images of a frame, the stereo image frame buffer including a three dimensional rendering surface. A fetcher fetches the two images from the stereo image frame buffer. An encoder encodes the two fetched images. A packager packages the two encoded images of the frame into a single data block for transmission to a remote viewer. A remote IHS receives the single data block via a network. The remote IHS may include a de-packager that receives a single data block that includes two encoded images of a frame. The de-packager de-packages the single data block into two encoded images. A decoder decodes the two encoded images of the frame. A sender sends the two decoded images to left and right buffers, respectively, of a three dimensional stereo rendering surface for display by the remote IHS which acts as a remote viewer.

### RELATED PATENT APPLICATIONS

This application claims priority to Foreign Patent Application No. EP 08151558.7 entitled “Method And System For Remote Three-Dimensional Stereo Image Display”, filed on Feb. 18, 2008, and claiming the same priority date, which is incorporated herein by reference and assigned to the same assignee herein.

### BACKGROUND

The disclosures herein relate generally to three-dimensional (3D) stereo image display systems, and more specifically, to remote 3D stereo image display systems.

Contemporary remote visualization systems may allow multiple collaborating users to access a workstation graphical console from a remote (thin) client system. Earlier remote visualization enabling software typically did not support 3D applications. A number of products offer support for using 3D applications through a remote viewer. Some of these products work by rendering the 3D image locally on the source workstation and then compressing and sending the resulting image through a network connection to the viewer, which displays the image on a display screen.

Remote applications such as Open Source VNC (Virtual Network Computing) or Microsoft Remote Desktop (Microsoft is a trademark of Microsoft Corporation) include support for 3D visualization applications. These applications use graphics APIs (application programming interfaces) for 3D rendering. For example, such graphics APIs include OpenGL (Open Graphics Library) (OpenGL is a trademark of Silicon Graphics, Inc.), and DirectX (DirectX is a trademark of Microsoft Corporation).

OpenGL is a standard cross-platform middleware Software Development Kit (SDK) for developing 3D applications. This SDK allows the application to access, in a multi-platform and multi-vendor environment, various 3D rendering primitives and leverages any and all available hardware support and acceleration on the host system. DirectX is a Microsoft alternative to OpenGL and allows Windows (Windows is a trademark of Microsoft Corporation) applications to use various 3D rendering primitives and leverages any hardware support and acceleration available in the host system.

3D graphics APIs can render 3D stereo images to give the user the illusion of real 3D objects. Several techniques for stereo display exist that provide different images for the left and the right eye to create the stereo effect. The following technologies show two different images to the user to create the 3D or stereo effect:
Head mounted display. In this approach, two different head mounted video displays display the two images to the user.
Active stereo. This system displays both images on the user's monitor in alternating fashion inside the same window on the monitor. The user may wear LCD shutter glasses that synchronize with the display to allow only one eye at a time to see the image.
Polarized stereo. This system projects the two images superimposed on the same (rear projection) screen using orthogonal or circular polarizing filters. The user wears polarized glasses, which decode the left and the right image.
Anaglyph stereo. This system combines the two images into a single image made up of two color layers, superimposed, but offset with respect to each other to produce a depth effect. Special glasses filter the image and decode the two color layers.

Since the anaglyph stereo approach employs a single image, this approach is usable by existing remote visualization technology without synchronization support. The other stereo approaches require two images per frame and synchronization support. Due to variable operating network conditions, end-to-end synchronization and reliable transport speed may not always be possible. Images may be lost or dropped to cope with the available network bandwidth.

### BRIEF SUMMARY

In one embodiment, a method of three-dimensional (3D) image processing is disclosed. The method includes providing a stereo image frame buffer that stores two images of a frame, the stereo image frame buffer including a three dimensional rendering surface. The method also includes fetching, by a fetcher, the two images from the stereo image frame buffer, thus providing two fetched images. The method further includes encoding, by an encoder, the two fetched images, thus providing two encoded images. The method still further includes packaging, by a packager, the two encoded images of the frame into a single data block.

In another embodiment, a method of three-dimensional (3D) image processing is disclosed. The method includes receiving, by a destination information handling system (IHS), a transmitted data block. The method also includes de-packaging, by a de-packager, the single data block into two encoded images of a frame, thus providing two de-packaged images. The method further includes decoding, by a decoder, the two de-packaged images, thus providing two decoded images. The method still further includes sending, by a sender, the two decoded images to left and right buffers, respectively, of a three dimensional stereo rendering surface for display.

In yet another embodiment, an information handling system (IHS) for three-dimensional (3D) image processing is disclosed. The IHS includes a stereo image frame buffer that stores two images of a frame, the stereo image frame buffer including a three dimensional rendering surface. The IHS also includes a fetcher, coupled to the stereo image frame buffer, that fetches the two images from the stereo image frame buffer, thus providing two fetched images. The IHS further includes an encoder, coupled to the fetcher, that encodes the two fetched images, thus providing two encoded images. The IHS still further includes a packager, coupled to the encoder, that packages the two encoded images of the frame into a single data block for transmission to a remote viewer.

In still another embodiment, a remote information handling system (IHS) for three-dimensional (3D) image processing is disclosed. The IHS includes a de-packager that receives a single data block that includes two encoded images of a frame, the de-packager de-packaging the single data block into two encoded images. The IHS also includes a decoder, coupled to the de-packager, that decodes the two encoded images of the frame, thus providing two decoded images. The IHS further includes a sender, coupled to the decoder, that sends the two decoded images to left and right buffers, respectively, of a three dimensional stereo rendering surface for display by the IHS which acts as a remote viewer.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of a remote visualization system in which a preferred embodiment of the present invention may be implemented.

FIG. 2 is a block diagram of a computer system in which a preferred embodiment of the present invention may be implemented.

FIGS. 3A and 3B are block diagrams of the server and client sides of a system in accordance with a preferred embodiment of the present invention.

FIG. 4 is a flow diagram of a process at a server system in accordance with an aspect of a preferred embodiment of the present invention.

FIG. 5 is a flow diagram of a process at a client system in accordance with another aspect of a preferred embodiment of the present invention.

### DETAILED DESCRIPTION

In one embodiment, the disclosed remote visualization system includes a server system that communicates with one or more remote client systems. The server system renders dual components of a 3D stereo image. The server system fetches, compresses and compacts the dual components of the 3D stereo image into a single network frame or single data block for transfer to the remote client system. This enables transfer of the dual components of the 3D stereo image to the remote client system without the need for synchronization between the dual components by the client system.

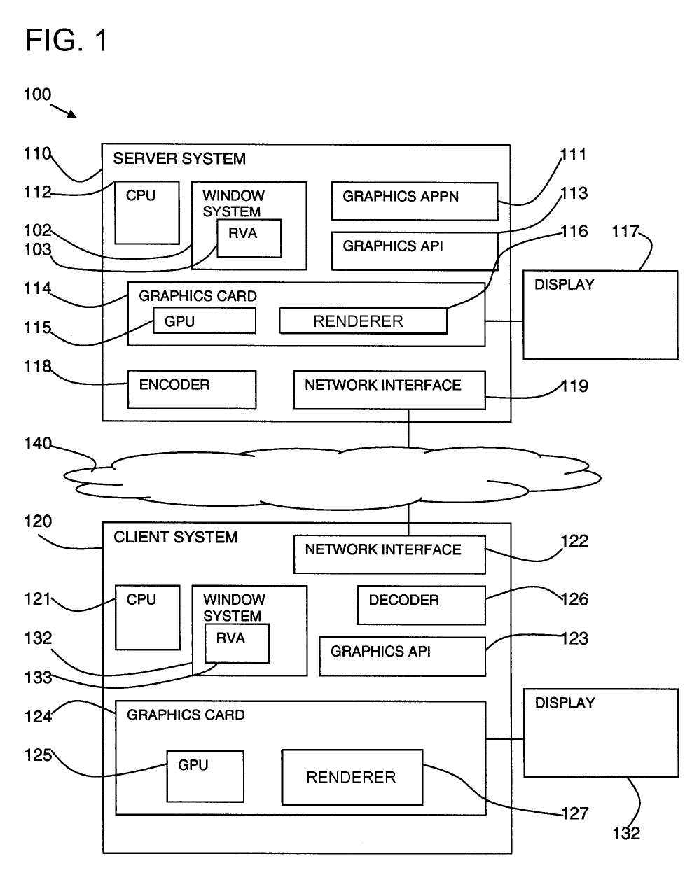

FIG. 1 shows one embodiment of the disclosed remote visualization system 100 as including a server system 110 and a remote client system 120. A graphics application (APPN) 111 executes on server system 110. Remote client system 120 couples to the server system 110 via a network 140. Remote client system 120 receives graphics from the graphics application 111 of the server system 110 over the network 140 for reproduction and display by remote client system 120.

Server system 110 is a data processing system or information handling system (IHS) that includes a CPU (central processing unit) 112 on which the graphics application 111 executes using a graphics application programming interface (API) 113. Server system 110 includes a server windowing system having a remote visualization adapter (RVA) module 103. Server system 110 also includes a graphics card 114 (also referred to as a video card, graphics accelerator card, or display adapter) that includes a GPU (graphics processing unit) 115 including a rendering circuit or renderer 116. Renderer 116 renders the graphics output that graphics application 111 provides. Server system 110 includes a local display 117 that may display the rendered output locally. Server system 110 acts as a source information handling system (IHS) for 3D stereo images.

Server system 110 includes an encoder 118 that encodes graphics application 111 output updates. The encoding may include compression of the graphics application output updates, or conversion to some other form for transmission. Server system 110 includes a network interface 119 for transmitting the encoded graphics application output updates via the network 140 to the remote client system 120 for display. Remote client system 120 is remote from server system 110 in the sense that remote client system 120 resides at a location different from the location of server system 110. Server system 110 acts as a source of 3D stereo images while remote client system 120 acts as a destination or target for 3D stereo images that server system 110 transmits. Remote client system 120 thus acts as a remote viewer IHS with respect to the transmitted 3D stereo images that source IHS or server system 110 transmits.

Client system 120 is a data processing system or IHS that includes a CPU 121. Client system 120 also includes a network interface 122 and a graphics API 123 for receiving the graphics application output updates from the server system 110 via network 140. Client system 120 includes a remote visualization adapter (RVA) module 133 on client's windowing system 132. Client system 120 acts as a remote destination information handling system (IHS).

Client system 120 includes a graphics card 124 with a GPU 125 including a rendering circuit or renderer 127 that renders the output of the graphics application 111. Client system 120 includes a decoder 126 that decodes the encoded graphics application output updates that client system 120 receives from server system 110. If the graphics application output updates are compressed output updates, then decoder 126 decompresses these compressed output updates. Client system 120 includes a display 132 that displays the output of graphics card 124 in the form of the received output from the graphics application 111 that executes on server system 110. Multiple client systems 120 may connect to a single server system 110 at the same time.

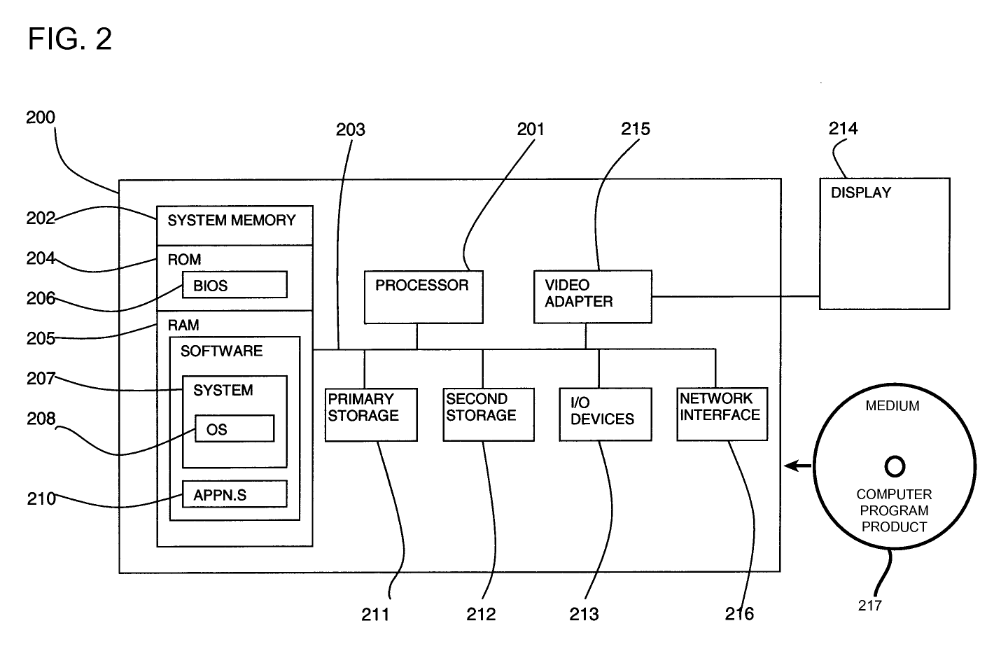

FIG. 2 is an exemplary data processing system 200 for implementing the server system 110 and a client system 120 of remote visualization system 100. Data processing system 200 is suitable for storing and/or executing program code. Data processing system 200 includes at least one processor 201 that couples directly or indirectly to memory elements through a bus system 203. The memory elements may include local memory that processor 201 employs during actual execution of the program code. The memory elements may also include bulk storage such as primary storage 211 and secondary storage 212. The memory elements may further include cache memories (not shown) that provide temporary storage of at least some program code to reduce the number of times that processor 201 must retrieve code from bulk storage during execution. The memory elements may also include system memory 202 in the form of read only memory (ROM) 204 and random access memory (RAM) 205. ROM 204 may store a basic input/output system (BIOS) 206. RAM 205 may store system software 207 including operating system software 208. RAM 205 may also store software applications 210.

Data processing system 200 may include a primary storage 211 such as a magnetic hard disk drive and a secondary storage 212 such as a magnetic disc drive and an optical disc drive. The drives and their associated computer-readable media provide non-volatile storage of computer-executable instructions, data structures, program modules and other data for data processing system 200. Software applications may store on primary storage 211 and secondary storage 212 as well as system memory 202. Data processing or computing system 200 may operate in a networked environment using logical connections to one or more remote computers via a network adapter or network interface 216.

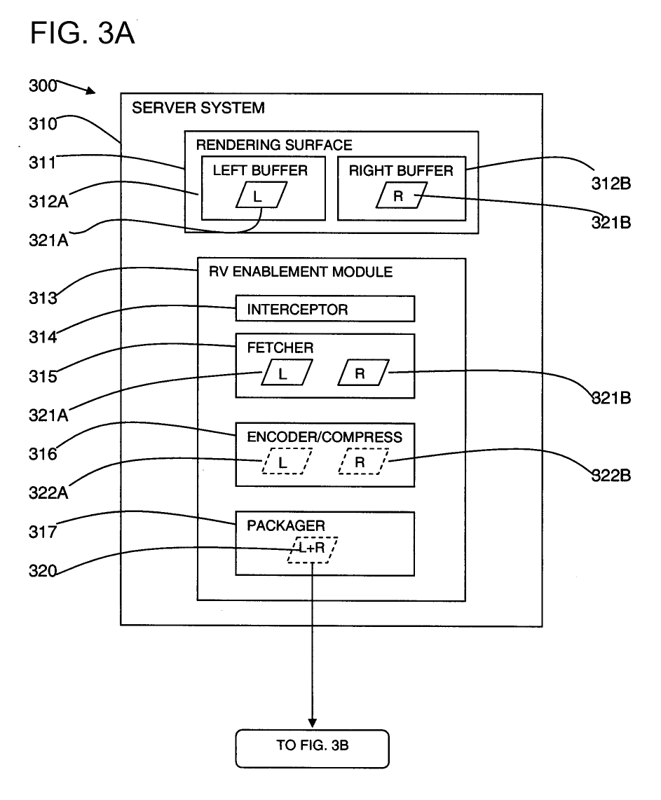

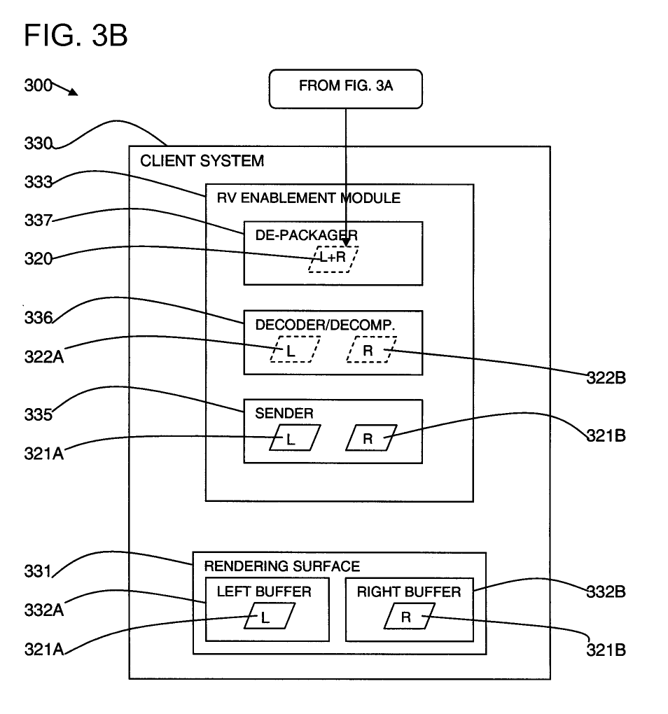

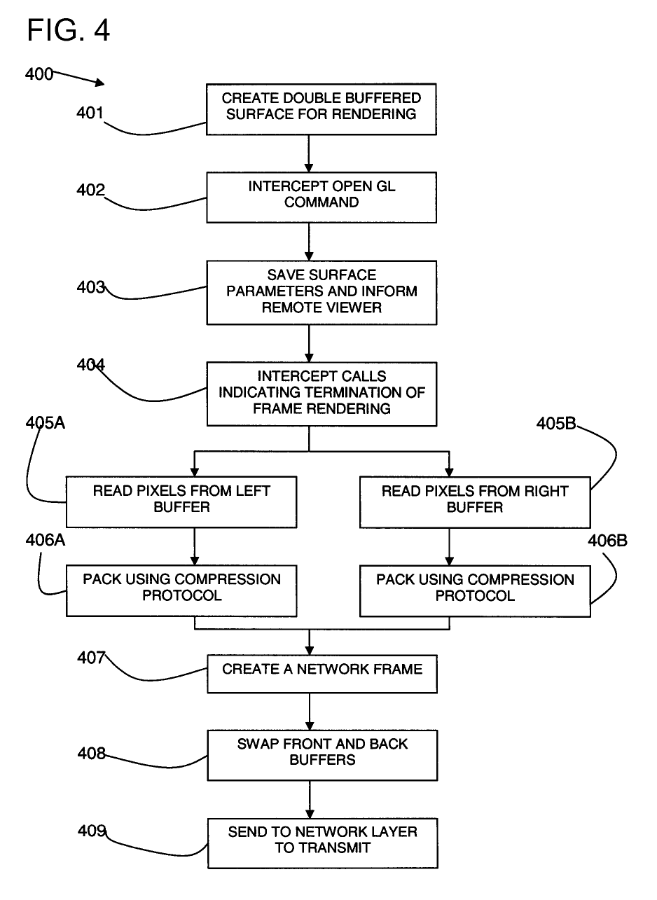

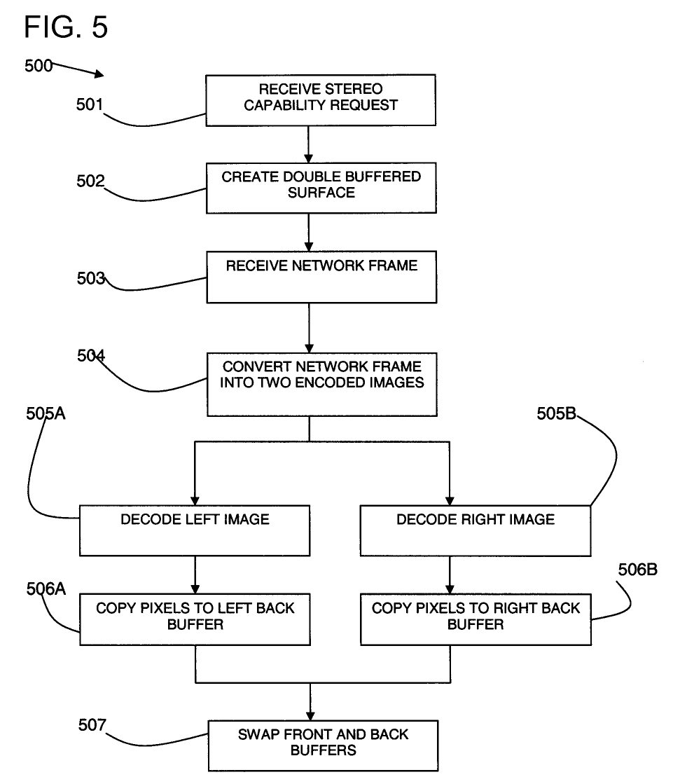

Input/output devices 213 may couple to system 200 either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, as well as other output devices. A display device 214 may connect to system bus 203 via an interface, such as video adapter 215. In one embodiment, system 200 includes a computer program product or medium 217 that include program code that instructs system 200 to carry out certain functions to implement the disclosed methodology. For example, when system 200 acts as a server system, then computer program product 217 includes appropriate programming or program code to instruct system 200 to carry out server system 110 functions such as described below with reference to FIG. 3A and the flowchart of FIG. 4. However, when system 200 acts as a remote client system, then computer program product 217 includes appropriate programming, program code or viewer software to instruct system 200 to carry out client system functions such as described below with reference to FIG. 3B and the flowchart of FIG. 5.

The disclosed remote visualization system includes a server system that communicates with a remote client system. The server system renders the dual components of a 3D stereo image. The server system also fetches, compresses and compacts the dual components of the 3D stereo image into a single network frame for transfer to the remote client system. This methodology permits transfer of the dual components of the 3D stereo image to the remote client system without the need for synchronization between the dual components by the client system.

FIGS. 3A and 3B together show a block diagram of remote visualization system 300 including 3D stereo image support. System 300 includes a server system 310, as shown in FIG. 3A. System 300 also includes a client system 330, as shown in FIG. 3B. Server system 310 renders a 3D stereo image for viewing on a remote viewer such as remote client system 330.

Server system 310 includes a 3D graphics API stereo surface 311, for example, an OpenGL stereo surface or a DirectX stereo surface. Stereo surface 311 is a rendering surface. Server system 310 renders a dual image 321A, 321B of a stereo frame with one image per eye, namely one image for the left eye of the user and one image for the right eye of the user. Server system 310 provides one of the dual images 321A in a left buffer 312A and the other of the dual images 321B in a right buffer 312B of the stereo rendering surface 311. Left buffer 312A together with right buffer 312B together form a frame buffer or rendering surface 311.

A 3D application may employ a technique of double buffering to avoid visual artifacts while drawing. Double buffering involves drawing a “back buffer” and displaying a “front buffer”. When drawing finishes the front and back buffers swap their respective contents so the application can draw again in the “back buffer”. System 300 time splices the left and right buffers 312A, 312B front-left, front-right and back-left, back-right. However, this is not mandatory and some applications may employ only a “front buffer” and those applications draw inside that buffer. The user may see some artifacts (incomplete drawing) in this case.

In more detail, system 300 includes a left buffer 312A and a right buffer 312B, and each of these buffers 312A, 312B may have either a front and a back buffer for double buffering or a single buffer. In the case of a the left and right buffers 312A, 312B each being a single buffer, the application does not use a swapping buffer function, but instead uses a flush or finish function to renew the buffer contents.

Server system 310 includes a remote visualization (RV) enablement module 313 as shown in FIG. 3A. The remote visualization enablement module 313 includes an interceptor 314 that intercepts 3D API commands. The interceptor 314 saves surface parameters and informs the remote client system 330 of a stereo capability request.

The remote visualization (RV) enablement module 313 also includes a fetcher 315 that fetches the dual images 321A, 321B from the left and right buffers 312A, 312B of the stereo surface 311 when the interceptor 314 intercepts the 3D API calls that signal the termination of the frame rendering in the surface 311. Module 313 also includes an encoder or compressor 316 for encoding or compressing the dual images 321A, 312B into encoded or compressed dual images 322A, 322B.

Module 313 further includes a packager 317 for packaging the encoded or compressed dual images 322A, 332B into a single block of data referred to here as a single network frame 320. The packager 317 combines the data from the two images 322A, 322B into a coherent block of data for sending to the remote client system 330. Several combining techniques may be used, for example, appending the second image after the first one, or interlacing the rows of the two images. The network frame 320 contains all the information needed at the receiving side to decode and display the image, such as position and size, timing information, and so forth. Server system 300 sends the single network frame 320 to client system 330 using a network transport protocol.

Client system 330 is a remote viewer that includes a remote visualization (RV) enablement module 333 as shown in FIG. 3B. The module 333 includes a de-packager 337 for decomposing the single network frame 320 into the encoded or compressed dual images 322A, 322B. A decoder or decompressor 336 decodes or decompresses the dual images 322A, 322B into the dual images 321A, 321B. A sender 335 sends the dual images 321A, 321B to a 3D stereo rendering surface 331 on client system 330 for display. The 3D rendering surface 331 employs left and right buffers 332A, 332B to which sender 335 sends dual images 321A, 321B for rendering and display. Client system 330 may support double buffering or single buffering at the left and right buffers 332A, 332B. Left buffer 332A together with right buffer 332B together form a frame buffer or rendering surface 331.

System 300 may employ different kinds of stereo modes and the 3D stereo rendering surface 331 at the client system 330 may display the received dual images 321A, 321B in different ways depending on the available hardware at client system 330. These different stereo modes may include: anaglyph, active and passive modes. System 300 processes the two images 321A, 322B for these different stereo modes as follows:
for anaglyph stereo mode, system 300 combines the two images in a single image (this is color polarization);
for active stereo mode, system 300 alternately displays the two images on the same display screen in synchronization with shutter glasses (this is time division);
for passive stereo mode, system 300 projects or displays both images on the display screen using filters (that is light polarization).

Each client system 330 receives the left and right images 321A, 321B and then decides how to display left and right images 321A, 321B depending on the hardware available in the particular client system 330. For a client system 330 that employs shutter glasses as a display, then that client system 300 will use active stereo mode. If the particular client system 330 employs two video projectors for display, then that client system 330 may use passive stereo mode. Otherwise, the particular client system 330 may combine the two images and display anaglyph stereo mode. Different client systems 330 may employ different stereo modes although these client systems receive information from the same server system 310 source.

The remote visualization system 100 or 300 operates by using a stereo surface and rendering a dual image stereo frame in server system 100 which may act as source workstation. The server system then fetches, encodes or compresses, and packs the two images into a single network frame for transmission to client system. The viewer creates a stereo surface on the display of the client system and activates synchronization of left and right buffers with the user glasses or activates dual output to separate projectors. The user of the client system configures a synchronization mechanism depending on available hardware and that synchronization mechanism be different from the synchronization mechanism that other collaborating users employ that connect to the same server system or to the mechanism used for the server display. If a client system has no special hardware to display a stereo image, the client system may combine the two images into an anaglyph stereo image. Upon receiving a network frame from the server system, the client system or viewer decodes or decompresses the two images and puts them into the left and right stereo buffers of the client system. Both images may be compressed (using the same codec and quality setting) without the loss of depth perception.

FIG. 4 is a flowchart 400 that shows an embodiment of the process at the server system or workstation system using graphics APIs stereo images, for example OpenGL or DirectX stereo images. On the 3D workstation or server system, the application creates a double buffered OpenGL or DirectX stereo surface for rendering, as per block 401. Remote visualization enablement software intercepts the OpenGL or DirectX command, as per block 402. The remote visualization enablement software saves the surface parameters and informs a remote viewer or client system of the stereo capability request, as per block 403.

The remote visualization enablement software intercepts the OpenGL or DirectX calls that signal termination of frame rendering, as per block 404. The remote visualization enablement software reads the pixels from a left buffer and from a right buffer, as per blocks 405A and 405B respectively. The server system packs the read images using any compression protocol, as per blocks 406A and 406B. The remote visualization enablement software creates a network frame which contains both the compressed image and gives the network frame to the networking layer, as per block 407. The remote visualization enablement software then swaps front and back buffers for both left and right frames, as per block 408. The “SwapBuffers” function is called glXSwapBuffers in UNIX (UNIX is a trademark of The Open Group) and wglSwapBuffers in Microsoft Windows (Windows is a trademark of Microsoft Corporation).

In an embodiment with single buffered frame buffers, the swapping step 408 is replaced by synchronizing on the drawing end (for example, intercepting glFinish/glFlush calls). The networking layer sends the network frame to the remote workstation or client server or drops the network frame if there is not enough bandwidth available, as per block 409.

FIG. 5 shows a flowchart 500 of an embodiment of the process at the remote client system using graphics APIs stereo images, for example, OpenGL or DirectX stereo images. The client system receives a stereo capability request, as per block 501. Viewer software creates a double buffered stereo OpenGL or DirectX 3D surface for receiving stereo data, as per block 502.

The client system receives a network frame as per block 503 and converts the network frame into two encoded i321mages, as per block 504. The client system decodes the two encoded images 505A, 505B into stereo images, as per block 505A and 505B, respectively. The client system copies the left image into the back buffer of the left buffer of the surface, as per block 506A. The client system copies the right image into the back buffer of the right buffer of the surface, as per block 506B.

The client system then swaps the contents of the front and back buffers for both images, as per block 507. The “SwapBuffers” function is called glXSwapBuffers in UNIX and wglSwapBuffers in Windows. In an embodiment with single buffered frame buffers, the swapping step 507 is replaced by synchronizing on the drawing end, namely the client server end (for example, intercepting glFinish/glFlush calls). In one embodiment, it is possible to provide a remote visualization enablement system as a service to a client over a network.

In one embodiment, a source workstation or source server system employs an OpenGL surface and renders a dual image stereo frame on that source. The source system fetches the two images of the dual image stereo frame, compresses the two images and then packages or packs the two fetched images into a single network frame. The source system sends the network frame to a remote viewer client system using a network transport protocol. The viewer client system creates an OpenGL surface on a screen or display and activates synchronization of left and right buffers with user glasses or output projectors. Upon receiving a network frame, the viewer client system decodes the two image of the network frame and stores these decoded images into left and right stereo buffers. The system may compress both images using the same codec and quality setting without the loss of depth perception.

The invention can take the form of an entirely hardware embodiment, an entirely software embodiment or an embodiment containing both hardware and software elements. In an embodiment, the invention is implemented in software, which includes but is not limited to firmware, resident software, microcode, etc.

The invention can take the form of a computer program product 217 accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of three-dimensional (3D) image processing, comprising:
providing a stereo image frame buffer that stores two images of a frame, the stereo image frame buffer including a three dimensional rendering surface;
fetching, by a fetcher, the two images from the stereo image frame buffer, thus providing two fetched images;
encoding, by an encoder, the two fetched images, thus providing two encoded images; and
packaging, by a packager, the two encoded images of the frame into a single data block.

2. The method of claim 1, wherein the encoding comprises compressing the two fetched images.

3. The method of claim 1, wherein the fetching of the two images by the fetcher is triggered by intercepting, by an interceptor, an application program interface call that indicates a termination of rendering of a frame in the stereo image frame buffer.

4. The method of claim 1, wherein one of the two images in the stereo image frame buffer is read from a left buffer in the stereo image frame buffer and the other of the two images is read from a right buffer in the stereo image frame buffer, the left and right buffers being included in the three dimensional rendering surface.

5. The method of claim 1, further comprising transmitting, by a source information handling system (IHS), the single data block to a remote destination IHS.

6. A method of three-dimensional (3D) image processing, comprising:
receiving, by a destination information handling system (IHS), a transmitted data block;
de-packaging, by a de-packager, the single data block into two encoded images of a frame, thus providing two de-packaged images.
decoding, by a decoder, the two de-packaged images, thus providing two decoded images; and
sending, by a sender, the two decoded images to left and right buffers, respectively, of a three dimensional stereo rendering surface for display.

7. The method of claim 6, wherein the three dimensional stereo rendering surface is an active surface.

8. The method of claim 6, wherein the three dimensional stereo rendering surface is a passive surface.

9. The method of claim 6, further comprising combining the two de-packaged images into a single anaglyphic stereo image and sending the single anaglyphic stereo image to a frame buffer for display.

10. The method of claim 6, wherein the decoding comprises decompressing the two de-packaged images.

11. An information handling system (IHS) for three-dimensional (3D) image processing, comprising:
a stereo image frame buffer that stores two images of a frame, the stereo image frame buffer including a three dimensional rendering surface;
a fetcher, coupled to the stereo image frame buffer, that fetches the two images from the stereo image frame buffer, thus providing two fetched images;
an encoder, coupled to the fetcher, that encodes the two fetched images, thus providing two encoded images; and
a packager, coupled to the encoder, that packages the two encoded images of the frame into a single data block for transmission to a remote viewer.

12. The IHS of claim 11, wherein the encoder compresses the two fetched images.

13. The IHS of claim 11, wherein the fetcher fetches the two images stored by the stereo image frame buffer in response to an interceptor intercepting an application program interface call that indicates a termination of rendering of a frame in the stereo image frame buffer.

14. The IHS of claim 11, wherein the stereo image frame buffer includes left and right buffers, and one of the two images in the stereo image frame buffer is read from the left buffer in the stereo image frame buffer and the other of the two images is read from the right buffer in the stereo image frame buffer, the left and right buffers being included in the three dimensional rendering surface.

15. The IHS of claim 11, wherein the IHS is a source IHS that transmits the single data block to a remote destination IHS.

16. A information handling system (IHS) for three-dimensional (3D) image processing, comprising:
a de-packager that receives a single data block that includes two encoded images of a frame, the de-packager de-packaging the single data block into two encoded images;
a decoder, coupled to the de-packager, that decodes the two encoded images of the frame, thus providing two decoded images;
a sender, coupled to the decoder, that sends the two decoded images to left and right buffers, respectively, of a three dimensional stereo rendering surface for display by the IHS which acts as a remote viewer.

17. The IHS of claim 16, wherein the decoder decompresses two encoded images.

18. The IHS of claim 16, wherein the three dimensional stereo rendering surface is an active surface.

19. The IHS of claim 16, wherein the three dimensional stereo rendering surface is a passive surface.

20. The IHS of claim 16, wherein the two de-packaged images are combined into a single anaglyphic stereo image and sent as a single anaglyphic stereo image to a frame buffer for display.

21. A computer program product stored on a computer operable medium, comprising:
instructions that receive a transmitted data block;
instructions that de-package the transmitted data block into two encoded images of a frame, thus providing two de-packaged images.
instructions that decode the two de-packaged images, thus providing two decoded images; and
instructions that send the two decoded images to left and right buffers, respectively, of a three dimensional stereo rendering surface for display.

22. The computer program product of claim 21, wherein the three dimensional stereo rendering surface is an active surface.

23. The computer program product of claim 21, wherein the three dimensional stereo rendering surface is a passive surface.

24. The computer program product of claim 21, further comprising instructions that combine the two de-packaged images into a single anaglyphic stereo image and send the single anaglyphic stereo image to a frame buffer for display.

25. The computer program product of claim 21, wherein the instructions that decode the two de-packaged images include instructions that decompress the two de-packaged images.
